(19) United States
(12) Patent Application Publication
(10) Pub. No.: US 2005/0009605 A1
(43) Pub. Date: Jan. 13, 2005

(54) Image-based control of video games

(76) Inventors: Steven T. Rosenberg, Palo Alto, CA (US); Todd A. Miklos, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/619,068

(22) Filed: Jul. 11, 2003

(51) Int. Cl. A63F 13/00

(52) U.S. Cl. 463/36

(57) ABSTRACT

Image-based video game control devices are described. In one aspect, a device for controlling a video game includes an input, an imager, and a movement detector. The input has a movable reference surface. The imager is operable to capture images of the reference surface. The movement detector is operable to detect movement of the reference surface based on one or more comparisons between images of the reference surface captured by the imager and to generate output signals for controlling the video game based on the detected movement. In another aspect, a device for controlling a video game includes a movable input, an imager, and a movement detector. The imager is attached to the input and is operable to capture images of a scene in the vicinity of the input. The movement detector is operable to compute three-dimensional position coordinates for the input based at least in part on one or more comparisons between images of the scene captured by the imager and to generate output signals for controlling the video game based on the computed position coordinates.

### TECHNICAL FIELD

This invention relates to devices for controlling video games.

### BACKGROUND

A video game is an electronic game that involves interaction between a user (or player) and a video game machine (e.g., a computer or a console) or that presents images and sounds to the user and responds to user commands through a user control interface (or video game controller). As used herein, the term “video game” refers broadly to traditional entertainment-type interactive video systems and to simulator-type interactive video systems. A wide variety of different user control interfaces have been developed, including joystick controllers, trackball controllers, steering wheel controllers, and computer mouse controllers. In addition, many different three-dimensional position-based controllers have been developed for virtual reality video games.

Analog position sensors, such a electrical contacts and switches, have been incorporated into video game controllers to detect movement of the physical input elements of the controllers. Optical encoders have been incorporated into digital joysticks and steering wheel controllers to replace analog sensors previously used to determine the joystick and steering wheel positions, which in turn determine the type of command signals that will be generated. In an optical mouse, a camera takes a plurality of images of a surface and a digital signal processor (DSP) detects patterns in the images and tracks how those patterns move in successive images. Based on the changes in the patterns over a sequence of images, the DSP determines the direction and distance of mouse movement and sends the corresponding displacement information to the video game machine. In response, the video game machine moves the cursor on a screen based on the displacement information received from the mouse.

Different types of three-dimensional video game controllers have been developed. Many three-dimensional video game controllers include multiple acceleration sensors that detect changes in acceleration of the video game controller in three dimensions. Other three-dimensional video game controllers include cameras that capture images of the player while the video game is being played. The video game machine processes the images to detect movement of the player or movement of an object carried by or on the player and changes the presentation of the video game in response to the detected movement.

### SUMMARY

The invention features image-based video game control devices.

In one aspect, the invention features a device for controlling a video game that includes an input, an imager, and a movement detector. The input has a movable reference surface. The imager is operable to capture images of the reference surface. The movement detector is operable to detect movement of the reference surface based on one or more comparisons between images of the reference surface captured by the imager and to generate output signals for controlling the video game based on the detected movement.

In another aspect, the invention features a device for controlling a video game that includes a movable input, an imager, and a movement detector. The imager is attached to the input and is operable to capture images of a scene in the vicinity of the input. The movement detector is operable to compute three-dimensional position coordinates for the input based at least in part on one or more comparisons between images of the scene captured by the imager and to generate output signals for controlling the video game based on the computed position coordinates.

Other features and advantages of the invention will become apparent from the following description, including the drawings and the claims.

### DESCRIPTION OF DRAWINGS

FIG. 1 is a block diagram of an embodiment of a device for controlling a video game.

FIG. 2 is a diagrammatic view of an implementation of the device of FIG. 1.

FIG. 3 is a diagrammatic view of an implementation of the device of FIG. 1.

FIG. 4 is a block diagram of an embodiment of a device for controlling a video game.

FIG. 5 is a diagrammatic view of an implementation of the device of FIG. 4.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

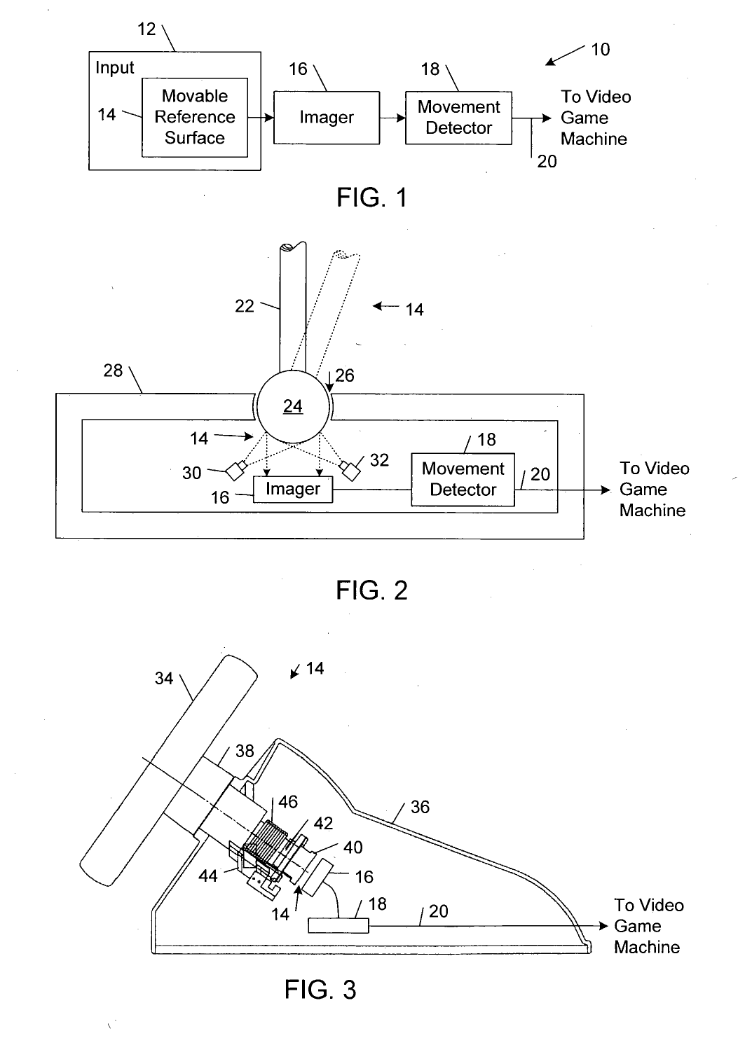

Referring to FIG. 1, in one embodiment, a device 10 for controlling a video game includes an input 12 with a movable reference surface 14, an imager 16, and a movement detector 18. Imager 16 captures a plurality of images of the reference surface 14. Movement detector 18 detects movement of the reference surface 14 based on one or more comparisons between images of the reference surface 14 that are captured by the imager 16. Movement detector 18 generates output signals 20 for controlling the video game based on the detected movement. The output signals 20 may be formatted to conform to any one of a wide variety of known and yet to be developed video game control signal specifications.

Input 12 may be any form of input device that includes at least one component that may be actuated or manipulated by a player to convey commands to the video game machine by movement of a reference surface. Exemplary input forms include a pivotable stick or handle (e.g., a joystick), a rotatable wheel (e.g., a steering wheel), a lever (e.g., a pedal), and a trackball. The moveable reference surface 14 may correspond to a surface of the actuatable or manipulable component or the reference surface 14 may correspond to a separate surface that tracks movement of the actuatable or manipulable component. In some implementations, the actuatable or manipulable component of the input 12 is coupled to a base that houses the imager 16 and the movement detector 18.

Imager 16 may be any form of imaging device that is capable of capturing one-dimensional or two-dimensional images of the reference surface. Imager 16 includes at least one image sensor. Exemplary image sensors include one-dimensional and two-dimensional CMOS (Complimentary Metal-Oxide Semiconductor) image sensors and CCD (Charge-Coupled Device) image sensors. Imager 16 captures images at a rate (e.g., 1500 pictures or frames per second or greater) that is fast enough so that sequential pictures of the reference surface 14 overlap. Imager 16 may include one or more optical elements that focus light reflecting from the reference surface 14 onto the one or more image sensors. In some embodiments, a light source (e.g., a light-emitting diode array) illuminates the reference surface 14 to increase the contrast in the image data that is captured by imager 16.

Movement detector 18 is not limited to any particular hardware or software configuration, but rather it may be implemented in any computing or processing environment, including in digital electronic circuitry or in computer hardware, firmware, or software. In one implementation, movement detector 18 includes a digital signal processor. These features may be, for example, inherent to the reference surface, relief patterns embossed on the reference surface, or marking patterns printed on the reference surface. Movement detector 18 detects movement of the reference surface 14 based on comparisons between images of the reference surface 14 that are captured by imager 16. In particular, movement detector 18 identifies texture or other features in the images and tracks the motion of such features across multiple images. Movement detector 18 identifies common features in sequential images and determines the direction and distance by which the identified common features are shifted or displaced. In some implementations, movement detector 18 correlates features identified in successive images to compare the positions of the features in successive images to provide information relating to the position of the reference surface 14 relative to imager 16. Movement detector 18 translates the displacement information into two-dimensional position coordinates (e.g., X and Y coordinates) that correspond to the movement of reference surface 14. Additional details relating to the image processing and correlating methods performed by movement detector 18 are found in U.S. Pat. Nos. 5,578,813, 5,644,139, 5,703,353, 5,729,008, 5,769,384, 5,825,044, 5,900,625, 6,005,681, 6,037,643, 6,049,338, 6,249,360, 6,259,826, and 6,233,368, each of which is incorporated herein by reference.

FIG. 2 shows an embodiment of the video game controlling device 10 in which the input 14 is implemented in the form of a joystick that includes a joystick shaft 22 with a spherical element 24 positioned in a socket 26 defined in a base 28. The spherical element 24 and socket 26 form a ball joint that allows the joystick shaft 22 to tilt about the spherical element 24 in socket 26 to indicate directions in a plane. Base 28 houses the imager 16 and the movement detector 18. In addition, base 28 contains a pair of light sources 30, 32 (e.g., light-emitting diode arrays) that are oriented to illuminate a portion of the surface of spherical element 24 that corresponds to reference surface 14. Imager 16 captures images of the reference surface 14 and movement detector 18 processes the images to detect movement of reference surface 14 and generate output signals 20 for controlling the video game, as explained above.

Although not shown, additional known components may be incorporated into the embodiment of FIG. 2 to maintain the joystick shaft 22 in a centered upright position when not in use and to return the joystick shaft 22 to the centered upright position when it is moved off center and released. In other embodiments, the ball joint formed by spherical element 24 and joystick shaft 22 may be replaced with other arrangements for supporting the joystick shaft 22. In addition, the joystick device shown in FIG. 2 may be incorporated into a video game controller that includes one or more additional known and yet to be developed components.

FIG. 3 shows an embodiment of the video game controlling device 10 in which the input 14 is implemented in the form of a steering wheel 34 that is coupled to a base 36 through a steering column 38. The steering wheel 34 is attached to one end of steering column 38 and the other end of steering column 38 is supported in an axel holder 40. A bushing 42 is attached to the steering column 38 and a spring holder 44 provides a stop edge for the bushing 42 to prevent steering column 38 from being pulled out of base 36. A torsion spring 46 is mounted around the steering column with one end attached to the steering column 38 and the other end attached to the spring holder 44. The torsion spring 46 returns the steering wheel 34 to an original neutral position after being turned and released. The bottom surface of the steering column 38 corresponds to reference surface 14. Imager 16 captures images of the reference surface 14 through a hole or window in axel holder 40. Movement detector 18 processes the images to detect rotation of reference surface 14 and to generate output signals 20 for controlling the video game, as explained above.

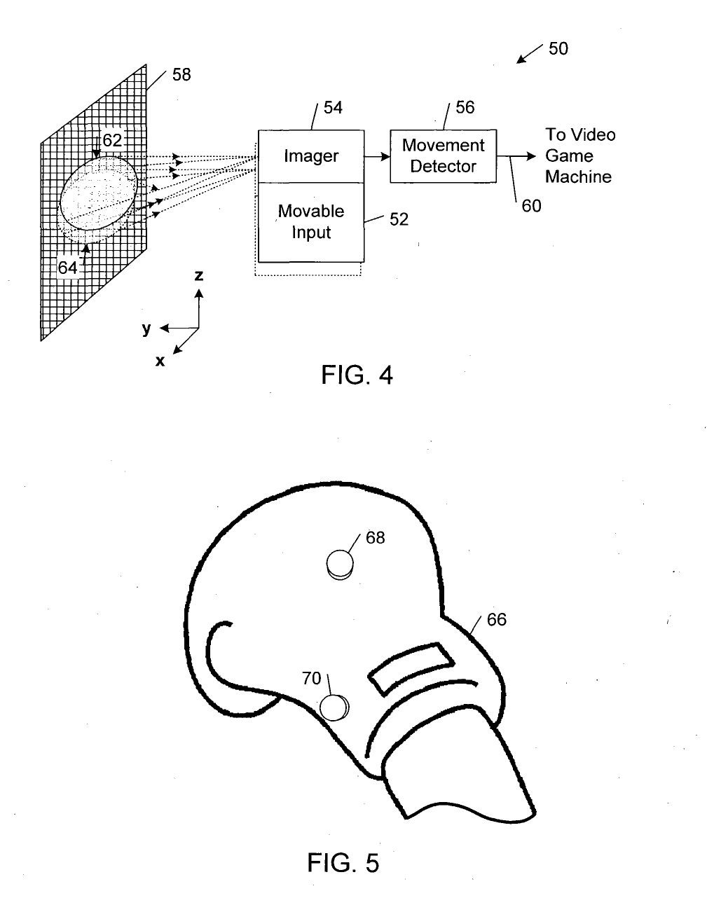

Referring to FIG. 4, in one embodiment, a device 50 for controlling a video game includes a movable input 52, an imager 54, and a movement detector 56. Imager 54 is attached to the input 52 and is operable to capture a plurality of images of a scene 58 in the vicinity of the input 52. In the illustrated embodiment, scene 58 is shown as a planar surface that includes a grid pattern. In general, scene 58 may correspond to any planar or non-planar view that contains structural or non-structural features that may be captured by imager 54 and tracked by movement detector 56. The movement detector 56 computes three-dimensional position coordinates for the input 52 based at least in part on one or more comparisons between images of the scene 58 captured by the imager 54. Movement detector 56 also generates output signals 60 for controlling the video game based on the computed position coordinates. The output signals may be formatted to conform to any one of a wide variety of known and yet to be developed video game control signal specifications.

Input 52 may be any form of input device that may be moved by a player in one or more dimensions to convey commands to the video game. Exemplary input forms include devices for simulating a sports game (e.g., a pair of boxing gloves, a baseball bat, a tennis racket, a golf club, a pair of ski poles, and a fishing pole), a helmet or hat, glasses or goggles, and items that may be worn (e.g., clothing) or carried (e.g., a stylus, baton, or brush) by the player.

Imager 54 may be any form of imaging device that is capable of capturing one-dimensional or two-dimensional images of the scene 58. In some embodiments, imager 54 includes multiple image sensors oriented to capture images at intersecting (e.g., orthogonal) image planes. Exemplary image sensors include one-dimensional and two-dimensional CMOS image sensors and CCD image sensors. As shown in FIG. 4, imager 54 moves with input 52 so that it captures different regions 62, 64 when the input 52 moves from one location to another (shown in FIG. 4 as a transition from the shadow line position to the solid line position). Imager 54 captures images at a rate (e.g., 1500 pictures or frames per second or greater) that is fast enough so that sequential pictures of the scene 58 overlap. Imager 54 may include one or more optical elements that focus light reflecting from the scene 58 onto the one or more image sensors. In some embodiments, a light source (e.g., a light-emitting diode array) illuminates the scene 58 to increase the contrast in the image data that is captured by imager 54.

Movement detector 56 is not limited to any particular hardware or software configuration, but rather it may be implemented in any computing or processing environment, including in digital electronic circuitry or in computer hardware, firmware, or software. In one implementation, movement detector 56 includes a digital signal processor. Movement detector 56 detects movement of the input 52 based on comparisons between images of the scene 58 that are captured by imager 54. In particular, movement detector 56 identifies structural or other features in the images and tracks the motion of such features across multiple images. Movement detector 56 identifies common features in sequential images and determines the direction and distance by which the identified common features are shifted or displaced. In some implementations, movement detector 56 correlates features identified in successive images to compare the positions of the features in successive images to provide information relating to the position of the input 52 relative to imager 16. Additional details relating to the image processing and correlating methods performed by movement detector 56 are found in U.S. Pat. Nos. 5,578,813, 5,644,139, 5,703,353, 5,729,008, 5,769,384, 5,825,044, 5,900,625, 6,005,681, 6,037,643, 6,049,338, 6,249,360, 6,259,826, and 6,233,368.

Movement detector 56 translates the displacement information computed based on images captured by a first image sensor of imager 54 into a first set of two-dimensional position coordinates (e.g., (X, Y)-coordinates) that indicate movement of input 52. Movement detector also computes displacement information based on images captured by a second image sensor of imager 54 that is oriented to capture images at an image plane that intersects the image plane of the first image sensor. Movement detector 56 translates the displacement information computed based on images captured by the second image sensor of imager 54 into a second set of two-dimensional position coordinates (e.g., (Y, Z)-coordinates or (Z, X)-coordinates) that indicate movement of input 52.

In some embodiments, each of six different directions (e.g., ±x, ±y, and ±z directions) is imaged by a respective pair of imagers. In these embodiments, in addition to computing displacement information, movement detector 56 tracks rotational position about the axes corresponding to the imaged directions based on image signals received from the pairs of imagers using any one of a variety of known optical navigation techniques (see, e.g., U.S. Pat. No. 5,644,139). In other embodiments, movement detector 56 is operable to compute rotational position about the axes corresponding to the imaged directions based on image signals received from a single camera for each axis using known inverse kinematic computation techniques.

Some implementations of video game controlling device 50 may include one or more accelerometers (e.g., MEMs (Micro Electro Mechanical Systems) accelerometer) that are oriented to measure acceleration of the movements of the input 52 in different respective directions (e.g., x, y, and z directions). Movement detector 56 may translate the acceleration measurements into coarse position coordinates for the input 52 using known double integration techniques. Movement detector 56 may compute refined position coordinates for the input based on the computed coarse position coordinates and comparisons between images of the scene captured by the imager 54. In some implementations, movement detector 56 may compute a coarse position window based on the coarse position coordinates and then may compute refined position coordinates based on comparisons of successive image areas falling within the coarse position window.

In some implementations, movement detector 56 computes primary position coordinates from accelerometers signals and periodically computes absolute position coordinates from comparisons between images of the scene 58 captured by imager 54. Movement detector 56 corrects for primary position coordinate drift caused by unintended accelerations and external acceleration sources based on the computed absolute position coordinates. In some implementations, movement detector 56 calibrates position information computed based on accelerometer signals by computing acceleration information relative to position coordinate information computed from comparisons between images of the scene 58 captured by imager 54. In this way, accelerations caused by, for example, global movements, which do not change the position of the imager 54 relative to scene 58, are factored out of the position coordinate computations.

In some embodiments, the frame rate at which images are captured by imager 54 may be adjusted dynamically based on movement information received from one or more accelerometers. For example, in one implementation, in response to measurement of motions with high acceleration and/or high integrated velocities, imager 54 is set to have a higher frame acquisition rate and, in response to measurement of slower motions (e.g., slower integrated velocities), imager 54 is set to a slower frame acquisition rate. In some instances, the acquisition frame rate is set to a predetermined low rate if the measured acceleration and/or integrated velocity is below a predetermined threshold, and the acquisition frame rate is set to a predetermined high rate if the measured acceleration and/or integrated velocity is above the predetermined threshold. In addition to improving accuracy, this technique may save power, especially when pulsed illumination is used to increase contrast or when the video game controlling device is battery-powered.

FIG. 5 shows an exemplary implementation of the video game controlling device 50 in which input 52 is implemented as a boxing glove 66 that may be used with a video game designed to simulate a boxing match. In this implementation, two image sensors 68, 70 are attached to the boxing glove 66. Image sensors 68, 70 are oriented in substantially orthogonal directions. Accelerometers also may be incorporated in or on the boxing glove 66 to provide acceleration measurements for computing coarse position coordinates for the boxing glove 66. Movement detector 56 may be incorporated within boxing glove 66. Alternatively, movement detector 56 may be positioned at a remote location and communicate wirelessly with image sensors 68, 70 and the accelerometers (if present).

Other embodiments are within the scope of the claims.

1. A device for controlling a video game, comprising:
an input having a movable reference surface;
an imager operable to capture images of the reference surface; and
a movement detector operable to detect movement of the reference surface based on one or more comparisons between images of the reference surface captured by the imager and to generate output signals for controlling the video game based on the detected movement.

2. The device of claim 1, wherein the input is a joystick and the reference surface moves in response to movement of the joystick.

3. The device of claim 2, wherein the input comprises a joystick shaft having a lower portion coupled to a base, and the reference surface corresponds to an area on the lower portion of the joystick shaft.

4. The device of claim 3, wherein the base includes a socket and the lower portion of the joystick shaft includes a spherical element positioned in the base socket and having a surface region corresponding to the reference surface.

5. The device of claim 1, wherein the input comprises a steering wheel coupled to a base through a steering column, and the reference surface tracks movement of the steering column.

6. The device of claim 5, wherein the reference surface corresponds to a surface of the steering column.

7. The device of claim 1, wherein the imager includes multiple image sensors each operable to capture images of the reference surface.

8. The device of claim 1, wherein the movement detector is operable to detect movement of the reference surface by tracking features of the reference surface across multiple images.

9. The device of claim 8, wherein the movement detector is operable to track structural features of the reference surface across multiple images.

10. The device of claim 8, wherein the movement detector is operable to compute position coordinates for the reference surface by correlating features of the reference surface across multiple images.

11. The device of claim 10, wherein the movement detector is operable to map the computed position coordinates to the output signals for controlling the video game.

12. The device of claim 1, further comprising at least one light source for illuminating the reference surface.

13. A device for controlling a video game, comprising:
a movable input;
an imager attached to the input and operable to capture images of a scene in the vicinity of the input; and
a movement detector operable to compute three-dimensional position coordinates for the input based at least in part on one or more comparisons between images of the scene captured by the imager and to generate output signals for controlling the video game based on the computed position coordinates.

14. The device of claim 13, wherein the movement detector is operable to compute rotational position of the movable input based at least in part on one or more comparisons between images of the scene captured by the imager.

15. The device of claim 13, wherein the input is a device for simulating a sports game.

16. The device of claim 15, wherein the input is formed in the shape of a glove.

17. The device of claim 13, further comprising an acceleration sensor unit attached to the input and operable to generate signals indicative of movement of the input in three-dimensions, wherein the movement detector is operable to detect movement of the input based at least in part on the signals generated by the acceleration sensor.

18. The device of claim 17, wherein the movement detector is operable to compute coarse three-dimensional position coordinates for the input based on the signals received from the acceleration sensor unit and to compute refined three-dimensional position coordinates for the input based on the computed coarse three-dimensional position coordinates and comparisons between images of the scene captured by the imager.

19. The device of claim 17, wherein the movement detector is operable to periodically correct three-dimensional position coordinates for the input computed from signals generated by the acceleration sensor based on position coordinates computed from comparisons between images of the scene captured by the imager.

20. The device of claim 17, wherein the movement detector is operable to compute acceleration information relative to position information computed from comparisons between images of the scene captured by the imager.

21. The device of claim 17, wherein the movement detector is operable to compute a measure of movement rate of the movable input based on the signals received from the acceleration sensor unit, and the imager captures images of the scene at a variable rate that is set based on the computed movement rate measure.

22. The device of claim 13, wherein the movement detector is operable to detect movement of the input by tracking features of the scene across multiple images.

23. The device of claim 13, wherein the movement detector is operable to compute position coordinates for the reference surface by correlating features of the reference surface across multiple images.

24. The device of claim 13, wherein the movement detector is operable to map the computed position coordinates to the output signals for controlling the video game.
